(19) United States
(12) Patent Application Publication
(10) Pub. No.: US 2026/0208226 A1
(43) Pub. Date: Jul. 23, 2026

(54) WEARABLE PAINT DISTRIBUTION SYSTEM

(71) Applicant: Jason Kelly, Monterey, CA (US)

(72) Inventor: Jason Kelly, Monterey, CA (US)

(21) Appl. No.: 19/031,612

(22) Filed: Jan. 18, 2025

(51) Int. Cl. B05C 17/00; A46B 11/06; B05C 1/00; B05C 11/10; B05C 11/11; B05C 17/03

(52) U.S. Cl. CPC B05C 17/002; A46B 11/063; B05C 1/00; B05C 11/1002; B05C 11/11; B05C 17/0341; A46B 2200/202

(57) ABSTRACT

A wearable paint distribution system to store paint therein and to distribute the paint therefrom, the wearable paint distribution system including a paint storing backpack to store the paint therein, a paint distribution device to receive the paint from the paint storing backpack at a first end of the paint distribution device and to expel the paint from a second end of the paint distribution device, a paint supply tube assembly to connect the paint storing backpack to the paint distribution device such that the paint can be transferred from the paint storing backpack to the paint distribution device, and a power supply assembly to supply electrical power to the paint distribution device to allow the paint distribution device to perform the paint expulsion.

### BACKGROUND

### 1. Field

The present general inventive concept relates generally to a paint distribution system, and particularly, to a wearable paint distribution system.

### 2. Description of the Related Art

Within the construction or D.I.Y. field, painting tasks are often managed by utilizing a primary paint gallon and standard brush or roller supplies to transfer paint onto a wall.

This process is very tedious, requires a great deal of additional supplies for transporting paint, and limits mobility when painting a site requiring a ladder or scaffolding to address.

Therefore, there is a need for a device that facilitates painting. SUMMARY The present general inventive concept provides a wearable paint distribution system.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a wearable paint distribution system to store paint therein and to distribute the paint therefrom, the wearable paint distribution system including a paint storing backpack to store the paint therein, a paint distribution device to receive the paint from the paint storing backpack at a first end of the paint distribution device and to expel the paint from a second end of the paint distribution device, a paint supply tube assembly to connect the paint storing backpack to the paint distribution device such that the paint can be transferred from the paint storing backpack to the paint distribution device, and a power supply assembly to supply electrical power to the paint distribution device to allow the paint distribution device to perform the paint expulsion.

The paint distribution device may include a paint distribution device pump to pump the paint from the paint storing backpack to the paint distribution device via the paint supply tube assembly upon activation of the paint distribution device pump, and a paint distribution device toggle button to activate the paint distribution device pump upon depression of the paint distribution device toggle button.

The wearable paint distribution system may further include at least one of a paint brush attachment and a paint roller attachment to connect to the second end of the paint distribution device to receive the paint therein, such that the paint is transferable to an outside medium.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a partially-exploded perspective view of a wearable paint distribution system, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Paint Can 10
Wearable Paint Distribution System 1000
Paint Storing Backpack 1100
Paint Storing Portion 1110
Straps 1120
Handle 1130
D-Rings 1140
Paint Receiving Nozzle 1150
Paint Distribution Device 1200
Paint Distribution Device Handle 1210
Paint Distribution Device Hand Support Ring 1211
Paint Distribution Device Adapter 1212
Paint Distribution Device Wiring Housing 1220
Paint Distribution Device Wiring 1221
Paint Distribution Device Power Receiving Connector 1222
Paint Distribution Device Pump 1230
Paint Distribution Device Pump Coupling Tube 1240
Paint Distribution Device Inner Tube 1250
Paint Distribution Device Inner Tube Nozzle 1251
Paint Distribution Device Nozzle Holding Member 1260
Paint Distribution Device Attachment Receiving Member 1270
Paint Distribution Device Toggle Button 1280
Paint Distribution Device Hook 1290
Paint Supply Tube Assembly 1300
Paint Supply Tube 1310
Shut Off Valve 1320
Three Way Connector 1330
Pump Routing Tube Connector 1340
Pump Routing Tube 1350
Push Connector 1351
Paint Intake Tube Receiving Connector 1360
Paint Intake Tube Supplying Connector 1370
Paint Intake Tube 1380
Paint Intake Tube Receiving Nozzle 1390
Power Supply Assembly 1400
Power Supply Circuit Board 1410
Power Supply Circuit Board Connector Receiving Unit 1411
Power Supply Circuit Board Power Button 1412
Power Supply Circuit Board Volume Control Knob 1413
Power Supply Circuit Board Battery Life Indicator 1414
Power Supply Housing 1420
Power Supply Housing Positive Terminal 1421
Power Supply Housing Negative Terminal 1422
Power Supply Housing Connector Receiving Port 1423
Power Supply Housing Power Button Depression Member 1424
Power Supply Housing Volume Control Knob Cover 1425
Power Supply Housing Battery Life Indicator Cover 1426
Battery 1430
Battery Positive Terminal 1431
Battery Negative Terminal 1432
Battery Charging Port 1433
Power Supply Assembly Casing 1500
Power Supply Assembly Casing Groove 1510
Power Supply Assembly Casing Belt Loops 1520
Power Transfer Cable Assembly 1600
Power Receiver Connector 1610
Power Transmitter Connector 1620
Power Transfer Cable 1630
Paint Brush Attachment 1700
Paint Brush Main Body 1710
Paint Brush Bristles 1711
Paint Brush Paint Expelling Valve 1712
Paint Brush Inner Tube 1713
Paint Brush Paint Receiving Tube 1720
Paint Brush Pump Connector 1730
Paint Roller Attachment 1800
Paint Roller Main Body 1810
Paint Roller Sleeve 1811
Paint Roller Paint Expelling Valve 1812
Paint Roller Inner Tube 1813
Paint Roller Paint Receiving Tube 1820
Paint Roller Pump Connector 1830

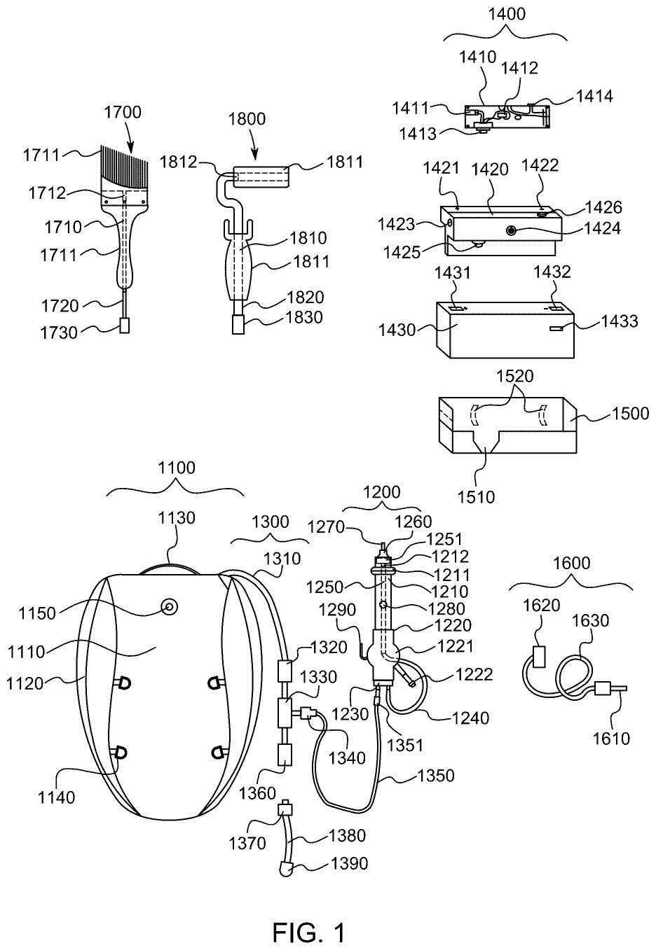

FIG. 1 illustrates a partially-exploded perspective view of a wearable paint distribution system 1000, according to an exemplary embodiment of the present general inventive concept.

The wearable paint distribution system 1000, and all components therein, may be constructed from at least one of plastic, paper, wood, cloth, fabric, nylon, metal, silicone, liquid, fibers, threads, fabric, foam, sponge, feathers, circuitry, glass, and rubber, etc., but is not limited thereto, and can be constructed from any material known to one of ordinary skill in the art.

Referring to FIG. 1, the wearable paint distribution system 1000 may include a paint storing backpack 1100, a paint distribution device 1200, a paint supply tube assembly 1300, a power supply assembly 1400, a power supply assembly casing 1500, a power transfer cable assembly 1600, a paint brush attachment 1700, and a paint roller attachment 1800, but is not limited thereto.

The paint storing backpack 1100 may include a paint storing portion 1110, a plurality of straps 1120, a handle 1130, a plurality of d-rings 1140, and a paint receiving nozzle 1150, but is not limited thereto.

The paint storing portion 1110 may be an inner portion of the paint storing backpack 1100 that has a lining that allows paint to be stored there inside.

The plurality of straps 1120 may be disposed at side portions of the paint storing backpack 1100 to allow a user to wear the paint storing backpack 1100.

The handle 1130 may be disposed at a top portion of the paint storing backpack 1100 to allow the user to carry the paint storing backpack 1100 with ease.

The plurality of d-rings 1140 may be disposed on surfaces of the paint storing backpack 1100.

The paint receiving nozzle 1150 may be disposed on a surface of the paint storing backpack 1100 to allow paint to be introduced into the paint storing portion 1110. The paint receiving nozzle 1150 may be either a male-type or a female-type of connector, based on a user's and/or a manufacturer's preference.

The paint distribution device 1200 may include a paint distribution device handle 1210, a paint distribution device hand support ring 1211, a paint distribution device adapter 1212, a paint distribution device wiring housing 1220, a paint distribution device wiring 1221, a paint distribution device power receiving connector 1222, a paint distribution device pump 1230, a paint distribution device pump coupling tube 1240, a paint distribution device inner tube 1250, a paint distribution device inner tube nozzle 1251, a paint distribution device nozzle holding member 1260, a paint distribution device attachment receiving member 1270, a paint distribution device toggle button 1280, and a paint distribution device hook 1290, but is not limited thereto.

The paint distribution device hook 1290 may allow a user to hook the paint distribution device 1200 onto an object or a belt of a user.

The paint distribution device handle 1210 may be a user-grippable portion of the paint distribution device 1200, and may include the paint distribution device hand support ring 1211 having a first side connected to a first end of the paint distribution device handle 1210, such that the paint distribution device hand support ring 1211 prevents a hand of the user from slipping off the paint distribution device handle 1210.

The paint distribution device adapter 1212 may have a first end connected to a second side of the paint distribution device hand support ring 1211, in order to secure the paint distribution device hand support ring 1211 in place.

The paint distribution device adapter 1212 may have a second end connected to the paint distribution device attachment receiving member 1270, which allows any attachable unit, such as the paint brush attachment 1700 and/or the paint roller attachment 1800, to be attached to the paint distribution device 1200. Thus, the paint distribution device attachment receiving member 1270 may be disposed at a first end, or tip, of the paint distribution device 1200.

The paint distribution device wiring housing 1220 may be connected to a second end of the paint distribution device handle 1210, and may include the paint distribution device wiring 1221 thereinside. The paint distribution device power receiving connector 1222 may be connected to the paint distribution device wiring 1221, and may protrude out from the paint distribution device wiring housing 1220 to allow the power supply assembly 1400 to be electrically connected to the paint distribution device 1200.

The paint distribution device pump 1230 may be disposed at a second end of the paint distribution device 1200, and may pump paint through paint distribution device pump coupling tube 1240 toward the paint distribution device inner tube 1250 disposed within the paint distribution device 1200, such that the paint is routed through the paint distribution device inner tube 1250 to the paint distribution device inner tube nozzle 1251 that is held in place by the paint distribution device nozzle holding member 1260, such that the paint may be expelled out of the paint distribution device attachment receiving member 1270 and received by the paint brush attachment 1700 and/or the paint roller attachment 1800.

The paint supply tube assembly 1300 may include a paint supply tube 1310, a shut off valve 1320, a three way connector 1330, a pump routing tube connector 1340, a pump routing tube 1350, a push connector 1351, a paint intake tube receiving connector 1360, a paint intake tube supplying connector 1370, a paint intake tube 1380, and a paint intake tube receiving nozzle 1390, but is not limited thereto.

The paint supply tube assembly 1300 may be connected at a first end to the paint storing backpack 1100, and may be connected at a second end to the paint distribution device 1200, such that paint stored within the paint storing backpack 1100 may be transferred to the paint distribution device 1200 via the paint supply tube assembly 1300.

The paint supply tube 1310 may be connected at a first end to the paint storing backpack 1100, and may be connected at a second end to the shut off valve 1320, which allows any paint flowing from the paint storing backpack 1100 to be turned on and/or shut off based on a user's preference.

The shut off valve 1320 may also be connected to the three way connector 1330.

The pump routing tube 1350 may be connected at a first end to the three way connector 1330 via the pump routing tube connector 1340, and may be connected at a second end to the paint distribution device 1200 (i.e., the paint distribution device pump 1230), so that when the shut off valve 1320 is open, the paint may be routed from the paint storing backpack 1100, through the paint supply tube 1310, through the shut off valve 1320, through the three way connector 1330, then through the pump routing tube connector 1340, then through the pump routing tube 1350, then through the push connector 1351, then into the paint distribution device pump 1230 of the paint distribution device 1200.

A user may want to transfer paint directly from an external paint bucket (e.g., a paint can and/or container containing paint thereinside) into the wearable paint distribution system 1000, and may do so via the paint intake tube 1380.

Specifically, the paint intake tube receiving connector 1360, which may be a shut off valve that can be opened and/or closed, may be connected to the three way connector 1330, and may also be connected to the paint intake tube 1380 via the paint intake tube supplying connector 1370 disposed at a first end of the paint intake tube 1380. A second end of the paint intake tube 1380 may be connected to the paint intake tube receiving nozzle 1390, which may be inserted into the paint bucket so that paint may be drawn out therefrom through the paint intake tube 1380. Thus, a user may fill the paint storing backpack 1100 via the paint receiving nozzle 1150 by connecting the paint distribution device attachment receiving member 1270 to the paint receiving nozzle 1150.

The power supply assembly 1400 may include a power supply circuit board 1410, a power supply housing 1420, and a battery 1430, but is not limited thereto.

The power supply circuit board 1410 may be configured to be fully disposed within the power supply housing 1420. Furthermore, the power supply housing 1420 (i.e., housing the power supply circuit board 1410) may be configured to have a portion thereof to be connected to a top portion of the battery 1430, thus establishing an electric connection between the power supply circuit board 1410 and the battery 1430.

The power supply circuit board 1410 may include a power supply circuit board connector receiving unit 1411, a power supply circuit board power button 1412, a power supply circuit board volume control knob 1413, and a power supply circuit board battery life indicator 1414, but is not limited thereto.

The power supply circuit board connector receiving unit 1411 may be disposed at a side portion thereof to electronically connect to the power transfer cable assembly 1600.

The power supply circuit board power button 1412 may allow a user to power on and/or off the wearable paint distribution system 1000 when it is pressed by the user.

The power supply circuit board volume control knob 1413 may be a knob that is rotatable by a user to adjust an amount of paint that is expelled through and out the paint distribution device 1200. Thus, the power supply circuit board volume control knob 1413 may control an intensity at which the paint distribution device pump 1230 pumps the paint throughout the wearable paint distribution system 1000. Accordingly, if a user turns the power supply circuit board volume control knob 1413 in a first direction, more paint may be pumped/expelled, and if the user turns the power supply circuit board volume control knob 1413 in a second direction, less paint may be pumped/expelled.

The power supply circuit board battery life indicator 1414 may be an indicator, such as a red or green light, to indicate the state of the battery 1430, and whether the battery needs to be recharged.

The power supply housing 1420 may include a power supply housing positive terminal 1421, a power supply housing negative terminal 1422, a power supply housing connector receiving port 1423, a power supply housing power button depression member 1424, a power supply housing volume control knob cover 1425, and a power supply housing battery life indicator cover 1426, but is not limited thereto.

The power supply housing positive terminal 1421 and the power supply housing negative terminal 1422 may be disposed at top portions and/or areas of the power supply housing 1420, and may both be electrically connected to the power supply circuit board 1410.

The power supply housing connector receiving port 1423 may correspond to the power supply circuit board connector receiving unit 1411 to provide a cover and protection therefor.

The power supply housing power button depression member 1424 may correspond to the power supply circuit board power button 1412 to provide a cover and protection therefor.

The power supply housing volume control knob cover 1425 may correspond to the power supply circuit board volume control knob 1413 to provide a cover and protection therefor.

The power supply housing battery life indicator cover 1426 may correspond to the power supply circuit board battery life indicator 1414 to provide a cover and protection therefor.

The battery 1430 may include a battery positive terminal 1431, a battery negative terminal 1432, and a battery charging port 1433, but is not limited thereto.

The battery positive terminal 1431 and the battery negative terminal 1432 may be disposed at top portions and/or areas of the battery 1430, and may correspond to the power supply housing positive terminal 1421 and the power supply housing negative terminal 1422, respectively, in order to provide power to the power supply circuit board 1410 when the power supply circuit board power button 1412 is pressed by the user.

The battery charging port 1433 may be any type of port known to one of ordinary skill in the art that allows for the battery 1430 to be charged, including, but not limited to, a USB port, a mini USB port, a micro USB port, a USB-C port, a lightning port, etc.

The power supply assembly casing 1500 may include a power supply assembly casing groove 1510, and a plurality of power supply assembly casing belt loops 1520, but is not limited thereto.

The power supply assembly casing 1500 may be configured to house both the battery 1430 and the power supply housing 1420 therein.

The power supply assembly casing groove 1510 may be a groove that allows a user to have better access to the power supply housing volume control knob cover 1425 (i.e., and the power supply circuit board volume control knob 1413).

The plurality of power supply assembly casing belt loops 1520 may be disposed on a surface of the power supply assembly casing 1500 to allow a user to thread a belt therethrough, thus allowing the user to wear the power supply assembly casing 1500 on the user's belt.

The power transfer cable assembly 1600 may include a power receiver connector 1610, a power transmitter connector 1620, and a power transfer cable 1630, but is not limited thereto.

The power receiver connector 1610 may be connected to a first end of the power transfer cable 1630, and the power transmitter connector 1620 may be connected to a second end of the power transfer cable 1630.

The power transfer cable assembly 1600 may connect the power supply assembly 1400 to the paint distribution device 1200.

Specifically, the first end of the power transfer cable 1630 including the power receiver connector 1610 may be inserted into the power supply housing connector receiving port 1423 of the power supply housing 1420 to be connected to the power supply circuit board connector receiving unit 1411 of the power supply circuit board 1410.

The second end of the power transfer cable 1630 including the power transmitter connector 1620 may be connected to the paint distribution device power receiving connector 1222 of the paint distribution device 1200.

Thus, the paint distribution device 1200 may receive power from the battery 1430 via the above-described connection of the power supply assembly 1400 to the paint distribution device 1200.

As such, the paint distribution device toggle button 1280 of the paint distribution device 1200 may be pressed by the user, which may activate the paint distribution device pump 1230, causing the paint to flow through the wearable paint distribution system 1000.

The paint brush attachment 1700 may include a paint brush main body 1710, a paint brush paint receiving tube 1720, and a paint brush pump connector 1730, but is not limited thereto.

The paint brush main body 1710 may include paint brush bristles 1711, a paint brush paint expelling valve 1712, a paint brush inner tube 1713, but is not limited thereto.

The paint brush main body 1710 may have a shape like any conventional paint brush, and the paint brush bristles 1711 may be actual bristles that allow a user to paint a surface. The paint brush inner tube 1713 may be disposed within the paint brush main body 1710, and may receive paint from the paint brush paint receiving tube 1720, which may be connected to the paint distribution device attachment receiving member 1270 of the paint distribution device 1200 via the paint brush pump connector 1730. In other words, the paint brush pump connector 1730 may be screwed onto and/or snapped onto the paint distribution device attachment receiving member 1270 of the paint distribution device 1200. As the paint is pumped from the paint distribution device 1200 through the paint brush inner tube 1713, the paint may be expelled out from the paint brush paint expelling valve 1712 into the paint brush bristles 1711, which may then be used to paint a surface using a stroking motion.

The paint roller attachment 1800 may include a paint roller main body 1810, a paint roller paint receiving tube 1820, and a paint roller pump connector 1830, but is not limited thereto.

The paint roller main body 1810 may include a paint roller sleeve 1811, a paint roller paint expelling valve 1812, and a paint roller inner tube 1813, but is not limited thereto.

The paint roller main body 1810 may have a shape like any conventional paint roller, and the paint roller sleeve 1811 may be an actual roller that spreads paint around as a user paints a surface with the paint roller attachment 1800. The paint roller inner tube 1813 may be disposed within the paint roller main body 1810, and may receive paint from the paint roller paint receiving tube 1820, which may be connected to the paint distribution device attachment receiving member 1270 of the paint distribution device 1200 via the paint roller pump connector 1830. In other words, the paint roller pump connector 1830 may be screwed onto and/or snapped onto the paint distribution device attachment receiving member 1270 of the paint distribution device 1200. As the paint is pumped from the paint distribution device 1200 through the paint roller inner tube 1813, the paint may be expelled out from the paint roller paint expelling valve 1812 into the paint roller sleeve 1811, which may then be used to paint a surface using a rolling motion.

The present general inventive concept may include a wearable paint distribution system 1000 to store paint therein and to distribute the paint therefrom, the wearable paint distribution system 1000 including a paint storing backpack 1100 to store the paint therein, a paint distribution device 1200 to receive the paint from the paint storing backpack 1100 at a first end of the paint distribution device 1200 and to expel the paint from a second end of the paint distribution device 1200, a paint supply tube assembly 1300 to connect the paint storing backpack 1100 to the paint distribution device 1200 such that the paint can be transferred from the paint storing backpack 1100 to the paint distribution device 1200, and a power supply assembly 1400 to supply electrical power to the paint distribution device 1200 to allow the paint distribution device 1200 to perform the paint expulsion.

The paint distribution device 1200 may include a paint distribution device pump 1230 to pump the paint from the paint storing backpack 1100 to the paint distribution device 1230 via the paint supply tube assembly 1300 upon activation of the paint distribution device pump 1230, and a paint distribution device toggle button 1280 to activate the paint distribution device pump 1230 upon depression of the paint distribution device toggle button 1280.

The wearable paint distribution system 1000 may further include at least one of a paint brush attachment 1700 and a paint roller attachment 1800 to connect to the second end of the paint distribution device 1200 to receive the paint therein, such that the paint is transferable to an outside medium.

A main purpose of the present general inventive concept is to provide users with a revolutionary paint transfer system designed to streamline and enhance the efficiency of tackling varied painting projects. Ingenious and practical, the present general inventive concept offers a modern wearable paint distribution system that redefines the paint application process providing users with unprecedented convenience and control. Expanding on the initial design of an accessory backpack, the present general inventive concept introduces a novel ergonomic option possessing ample storage for paint or other materials, to be stored within its reservoir compartment holding roughly 3 liters, ensuring easy access to the material while minimizing downtime for product refills. Comprised of quality stainless steel, barbed brass, and other materials along with a series of internally housed connection tubes and fittings, the present general inventive concept, when worn, efficiently transfers paint from the reservoir backpack to a primary brush accessory, seamlessly, allowing for immediate paint access to optimize workflow. The present general inventive concept permits the user to regulate the volume of material being fed into the pump via a handheld power source switch conveniently located on the fastening belt allowing for controlled paint delivery, resulting in professional quality finishes every time while safeguarding against leaks and/or damage to electrical components within the device. To further enhance functionality, the present general inventive concept is completely wireless and employs a compact charger able to maintain adequate power for long-term utilization. This innovative, top-quality product offers an effective painting tool that can also be used for cleaner solutions and/or other projects requiring systemic access to liquid materials. As a result, the present general inventive concept may prove to be essential in the painting/hardware industry.

The present general inventive concept is the only product of its kind that offers a wearable painting distribution accessory developed to significantly enhance paint application technology, offering unparalleled efficiency, convenience, and reliability. This unprecedented product is uniquely designed with user-friendly, cutting-edge features, such as a digital battery life indicator, adjustable shoulder straps for secured comfort when worn, and internal leak-proof safety measures. Furthermore, the present general inventive concept was defined by a professional with over 20 years of experience in the painting industry.

As will be appreciated by a person of ordinary skill in the art, aspects of the present general inventive concept may be embodied as a method, a device, a system, or a computer program product, for example. Accordingly, aspects of the present general inventive concept may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present general inventive concept may take the form of a computer program product embodied in one or more computer-readable data storage devices or computer-readable data storage components that include computer-readable medium(s) having computer readable program code embodied thereon. For example, a computer-readable data storage device may be embodied as a tangible device that may include a tangible data storage medium (which may be non-transitory in some examples), as well as a controller configured for receiving instructions from a resource such as a central processing unit (CPU) to retrieve information stored at one or more particular addresses in the tangible, non-transitory data storage medium, and for retrieving and providing the information stored at those particular one or more addresses in the data storage medium.

The data storage device may store information that encodes both instructions and data, for example, and may retrieve and communicate information encoding instructions and/or data to other resources such as a CPU, for example. The data storage device may take the form of a main memory component such as a hard disc drive or a flash drive in various embodiments, for example. The data storage device may also take the form of another memory component such as a RAM integrated circuit or a buffer or a local cache in any of a variety of forms, in various embodiments. This may include a cache integrated with a controller, a cache integrated with a graphics processing unit (GPU), a cache integrated with a system bus, a cache integrated with a multi-chip die, a cache integrated within a CPU, or the processor registers within a CPU, as various illustrative examples. The data storage apparatus or data storage system may also take a distributed form such as a redundant array of independent discs (RAID) system or a cloud-based data storage service, and still be considered to be a data storage component or data storage system as a part of or a component of an embodiment of a system of the present general inventive concept, in various embodiments.

Any combination of one or more computer readable medium(s) may be utilized. The computer readable medium may be a computer readable signal medium or a computer readable storage medium. A computer readable storage medium may be, for example, but is not limited to, an electronic, magnetic, optical, electromagnetic, infrared, electro-optic, heat-assisted magnetic, or semiconductor system, apparatus, or device, or any suitable combination of the foregoing. A non-exhaustive list of additional specific examples of a computer readable storage medium includes the following: an electrical connection having one or more wires, a portable computer diskette, a hard disc, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device, for example.

Program code embodied on a computer readable medium may be transmitted using any appropriate medium, including but not limited to radio frequency (RF) or other wireless, wire line, optical fiber cable, etc., or any suitable combination of the foregoing. Computer program code for carrying out operations for aspects of the present general inventive concept may be written in any combination of one or more programming languages, including an object oriented programming language such as Java, Smalltalk, C++, or the like, or other imperative programming languages such as C, or functional languages such as Common Lisp, Haskell, or Clojure, or multi-paradigm languages such as C #, Python, or Ruby, among a variety of illustrative examples. One or more sets of applicable program code may execute partly or entirely on the user's desktop or laptop computer, smartphone, tablet, or other computing device; as a stand-alone software package, partly on the user's computing device and partly on a remote computing device; or entirely on one or more remote servers or other computing devices, among various examples. In the latter scenario, the remote computing device may be connected to the user's computing device through any type of network, including a local area network (LAN) or a wide area network (WAN), or the connection may be made to an external computer (for example, through a public network such as the Internet using an Internet Service Provider), and for which a virtual private network (VPN) may also optionally be used.

In various illustrative embodiments, various computer programs, software applications, modules, or other software elements may be executed in connection with one or more user interfaces being executed on a client computing device, that may also interact with one or more web server applications that may be running on one or more servers or other separate computing devices and may be executing or accessing other computer programs, software applications, modules, databases, data stores, or other software elements or data structures. A graphical user interface may be executed on a client computing device and may access applications from the one or more web server applications, for example. Various content within a browser or dedicated application graphical user interface may be rendered or executed in or in association with the web browser using any combination of any release version of HTML, CSS, JavaScript, XML, AJAX, JSON, and various other languages or technologies. Other content may be provided by computer programs, software applications, modules, or other elements executed on the one or more web servers and written in any programming language and/or using or accessing any computer programs, software elements, data structures, or technologies, in various illustrative embodiments.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A wearable paint distribution system to store paint therein and to distribute the paint therefrom, the wearable paint distribution system comprising:
a paint storing backpack to store the paint therein;
a paint distribution device to receive the paint from the paint storing backpack at a first end of the paint distribution device and to expel the paint from a second end of the paint distribution device;
a paint supply tube assembly to connect the paint storing backpack to the paint distribution device such that the paint can be transferred from the paint storing backpack to the paint distribution device; and
a power supply assembly to supply electrical power to the paint distribution device to allow the paint distribution device to perform the paint expulsion,
wherein the paint distribution device comprises:
a paint distribution device pump disposed within the paint distribution device to pump the paint from the paint storing backpack to the paint distribution device via the paint supply tube assembly upon activation of the paint distribution device pump; and
a paint distribution device toggle button to activate the paint distribution device pump upon depression of the paint distribution device toggle button.

2. (canceled)

3. The wearable paint distribution system of claim 1, further comprising:
at least one of a paint brush attachment and a paint roller attachment to connect to the second end of the paint distribution device to receive the paint therein, such that the paint is transferable to an outside medium.
